(19) United States
(12) Patent Application Publication
(10) Pub. No.: US 2008/0247038 A1
(43) Pub. Date: Oct. 9, 2008

(54) SCANNING CONFOCAL MICROSCOPE

(75) Inventors: Hiroshi SASAKI, Tokyo (JP); Tatsuo Nakata, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/058,956

(22) Filed: Mar. 31, 2008

(30) Foreign Application Priority Data
Apr. 4, 2007 (JP) 2007-098630

(51) Int. Cl. G02B 21/26

(52) U.S. Cl. 359/395

(57) ABSTRACT

A scanning confocal microscope can provide an image while preventing a decrease in brightness and blurring due to strain caused in optical and mechanical systems by thermal effects in a high-temperature, high-humidity incubation container. This scanning confocal microscope includes an incubation container that has a space in which a specimen is disposed and that can maintain an internal environment thereof at a predetermined temperature and high humidity and an optical system space adjacent to the incubation container and separated therefrom based on humidity. The optical system space accommodates a light-scanning unit and a scanner optical system, an objective lens, a confocal pinhole, and a focus adjustment mechanism. The optical system space further accommodates a temperature-maintaining unit for the optical system space to maintain the optical system space at a temperature substantially equal to the temperature in the incubation container.

### BACKGROUND OF THE INVENTION

1. Field of the Invention

The present invention relates to scanning confocal microscopes.

This application is based on Japanese Patent Application No. 2007-098630, the content of which is incorporated herein by reference.

2. Description of Related Art

Among known microscopes is a scanning confocal microscope, which is capable of observation with three-dimensional resolution by detecting light through a confocal pinhole (for example, see Japanese Unexamined Patent Application, Publication No. 2004-86009).

Also known is an examination system for long-term examination of changes in living cells over time (for example, see Japanese Unexamined Patent Application, Publication No. 2006-115760). To allow the cells to live for a long period of time, this system includes an incubator, mounted on a stage of an inverted microscope, for providing the cells with a high-temperature, high-humidity environment, and the incubator is maintained at a temperature of 37° C. and a humidity of 100%.

Simply mounting the incubator on the stage of the inverted microscope, however, leaves a temperature difference between the incubator and the inverted microscope. This causes an undesirable temperature gradient in the microscope and its scanning unit. Such a temperature gradient in the optical components can distort the optical system, thus causing a shifting of the examination site during long-term examination.

A scanning confocal microscope, in particular, is more susceptible to a shifting of the examination site on a cell due to slight thermal strain than a typical optical microscope because, for example, the microscope has high resolution in the optical-axis direction, its magnification can be greatly increased by reducing the scanning angle (i.e., scanning range) of a galvanometer mirror, which serves as a light-scanning unit, and the examination depends equally on the positional accuracy of the optical axis on the illumination side and that on the detection side. In addition, a shift in the angle of the optical axis causes a shift in the focal position of the light in a confocal pinhole, thus causing the problems of darkening and impaired confocal effect.

The spot diameter of light focused in a confocal pinhole by a confocal lens is represented by the equation d=1.22×λ/NA, where λ is the wavelength of the light and NA is the numerical aperture of the light projected in the pinhole. If λ is 520 nm and NA is 0.01, d=63 μm. The diameter of the pinhole is set to be similar to the spot diameter. If the confocal lens has a focal length of 150 mm and the angle of the light incident on the confocal lens deviates by an angle of 1′ due to strain in the optical or mechanical system, the spot deviation is determined to be 150 mm×tan 1′=47 μm. As a result, more than half the area of the spot lies outside the pinhole.

### BRIEF SUMMARY OF THE INVENTION

The present invention provides a scanning confocal microscope capable of providing an image of a specimen under examination using a high-temperature, high-humidity incubation container without causing a shifting of the examination site, decreased brightness, or blurring.

The present invention provides a scanning confocal microscope including an incubation container that has a space in which a specimen is disposed and that can maintain an internal environment thereof at a predetermined temperature and high humidity and an optical system space adjacent to the incubation container and separated therefrom based on humidity. The optical system space accommodates a light-scanning unit and a scanner optical system configured to scan the specimen with laser light in two dimensions, an objective lens configured to focus the laser light scanned by the light-scanning unit on the specimen and to collect light from the specimen, a confocal pinhole through which the light collected by the objective lens passes after passing through the scanner optical system and the light-scanning unit, and a focus adjustment mechanism configured to actuate the objective lens in an optical-axis direction. The optical system space further accommodates a temperature-maintaining unit for the optical system space to maintain the optical system space at a temperature substantially equal to the temperature in the incubation container.

According to the present invention, the specimen disposed in the incubation container can be maintained in a healthy condition for a long period of time because the internal environment is maintained at a predetermined temperature and high humidity. The optical system space, on the other hand, is separated from the incubation container based on humidity, so that the high humidity in the incubation container can be prevented from affecting optical systems, such as the scanner optical system, the objective lens, and the confocal pinhole, and mechanical systems, such as the focus adjustment mechanism. In addition, the temperature-maintaining unit disposed in the optical system space operates to maintain the optical system space at a temperature substantially equal to the temperature in the incubation container, thus preventing formation of a temperature gradient in the optical and mechanical systems in the optical system space due to the temperature in the incubation container. This effectively prevents strain in the optical and mechanical systems and, therefore, blurring and decreased brightness of a resultant image.

In the above invention, the optical system space may accommodate the incubation container.

This allows the temperature in the optical system space to be readily maintained at a temperature substantially equal to the temperature in the incubation container.

In the above invention, additionally, the incubation container may be disposed in an examination space separated from the incubation container based on humidity, and the examination space may accommodate a temperature-maintaining unit for the examination space to maintain the examination space at a temperature substantially equal to the temperature in the incubation container.

This allows the temperature-maintaining units for the optical system space and the examination space to effectively prevent formation of a temperature gradient in the entire system.

In the above invention, additionally, the incubation container may be maintained at a temperature of 37±1° C. and a humidity of 90% to 100%.

In the above invention, additionally, the temperature-maintaining unit for the optical system space may maintain the optical system space at a predetermined temperature between about 30° C. and 37° C.

This allows the specimen to be maintained in a live, healthy condition for a long period of time if the specimen is a living cell.

In the above invention, the temperature-maintaining unit for the optical system space may include a temperature sensor configured to measure the temperature in the optical system space and a heating unit configured to heat air in the optical system space. In addition, the temperature-maintaining unit for the examination space may include a temperature sensor configured to measure the temperature in the examination space and a heating unit configured to heat air in the examination space.

This allows the temperature sensors to detect the temperatures and the heating units to heat the air in the optical system space and the examination space, so that they can be accurately maintained at a desired temperature.

In the above invention, the heating units may be hot-air supplying units configured to supply air maintained at constant temperature. This allows the optical system space and/or the examination space to be readily maintained at a desired temperature simply by supplying the air maintained at the desired temperature from the hot-air supplying units.

In the above invention, the optical system space may further accommodate a laser light source configured to emit the laser light and a laser-light introducing optical system configured to guide the laser light emitted from the laser light source to the light-scanning unit.

This allows the single temperature-maintaining unit to maintain the optical system space, including the laser light source and the laser-light introducing optical system, at constant temperature.

In the above invention, alternatively, a laser light source configured to emit the laser light may be disposed outside the optical system space, and an optical fiber configured to guide the laser light emitted from the laser light source into the optical system space may be provided.

The laser light source, which is generally a heat source, may be disposed outside the optical system space, and only the laser light may be introduced into the optical system space through the optical fiber. This prevents heat from the laser light source affecting the other optical and mechanical systems, so that the optical system space can be more readily maintained at constant temperature.

In the above invention, additionally, a light detector configured to detect the light passing through the confocal pinhole may be disposed outside the optical system space.

Disposing the light detector, which is generally a heat source, outside the optical system space prevents the heat from the light detector affecting the other optical and mechanical systems, so that the optical system space can be more readily maintained at constant temperature, and also prevents a rise in the temperature of the light detector to avoid a decrease in the S/N ratio of an image due to electrical noise.

In the above invention, additionally, the optical system space may be surrounded by an outer cover formed of a heat insulator.

This allows the outer cover to prevent variations in outside air temperature from affecting the optical and mechanical systems in the optical system space, so that they can be more accurately maintained at constant temperature.

In the above invention, additionally, control parameters, including at least one of the scanning range and scanning position of the laser light on the specimen by the scanner optical system, and the position of the confocal pinhole, may be set with the optical system space maintained at a temperature in use by the temperature-maintaining unit for the optical system space.

This prevents variations in the quality of an image acquired after long-term examination because the optical and mechanical systems have been adjusted under stable conditions with few variations, and also suppresses a deviation in the scanning range and scanning position of the laser light or a shift in the position of the confocal pinhole from the spot position where the light from the specimen is focused in the confocal pinhole in long-term examination after the adjustment of the control parameters.

In the above invention, additionally, a parameter-storing unit may be provided to store the control parameters in correspondence with temperatures in the optical system space.

This allows appropriate control parameters for different temperatures to be retrieved from the parameter-storing unit and quickly set when the temperature in the optical system space is changed before examination.

In the above invention, additionally, the optical system space may further accommodate a fan configured to produce an air flow in the optical system space, and an air-flow shielding member may be disposed around an optical path of the laser light.

This allows the temperature in the optical system space to be made uniform under the effect of the air flow produced by the fan and facilitates cooling of the optical or mechanical systems. In this case, the air-flow shielding member disposed around the optical path of the laser light can prevent the air flow from affecting the laser light.

In the above invention, additionally, the air-flow shielding member may have an outer surface subjected to blackening treatment.

The blackening treatment allows the outer surface of the air-flow shielding member to absorb outside heat and to isolate the inside of the air-flow shielding member from the atmosphere in the optical system space, which is at a relatively high temperature, thus preventing formation of a temperature gradient.

In the above invention, additionally, a resin cover may be provided so as to cover a metal portion at a tip of the objective lens.

This suppresses heat transfer from the metal portion at the tip of the objective lens into the opposing incubation container.

In the above invention, additionally, the laser light source may be a semiconductor laser, and a heat-transferring member may be provided so as to transfer heat generated by the laser light source to the outside of the optical system space.

Transferring the heat generated by the semiconductor laser to the outside of the optical system space with the heat-transferring member allows the heat generated by the semiconductor laser, which is a heat source, in the optical system space to be released to the outside of the optical system space, so that the optical system space can be readily maintained at constant temperature.

In the above invention, additionally, the heat-transferring member may be a heat pipe, and a heat-dissipating member may be disposed at an end of the heat-transferring member outside the optical system space.

This allows the heat generated by the semiconductor laser to be more efficiently released to the outside of the optical system space.

In the above invention, additionally, a liquid-immersion-medium supplying unit may be provided to supply a liquid-immersion medium between the objective lens and the specimen.

Providing the liquid-immersion-medium supplying unit to supply the liquid-immersion medium between the objective lens and the specimen allows high-resolution examination.

In the above invention, additionally, a cooled photomultiplier tube may be disposed in the optical system space as a light detector, and a heat-transferring member may be provided so as to transfer heat generated by the light detector to the outside of the optical system space.

Transferring the heat generated by the cooled photomultiplier tube to the outside of the optical system space with the heat-transferring member allows the heat generated by the cooled photomultiplier tube, which is a heat source, in the optical system space to be released to the outside of the optical system space, so that the optical system space can be readily maintained at constant temperature.

In the above invention, additionally, the scanner optical system may include a pupil projection lens and a focusing lens, and a pupil-projection-magnification changing unit may be provided to change the pupil projection magnification based on the ratio of the focal length of the pupil projection lens to the focal length of the focusing lens.

This allows examination in a wide magnification range, from low magnification to high magnification, using the single objective lens by operating the pupil-projection-magnification changing unit.

In the above invention, additionally, the pupil-projection-magnification changing unit may include a zoom lens constituting at least one of the pupil projection lens and the focusing lens.

This allows the pupil projection magnification to be continuously changed for adjustment of the examination magnification by operating the zoom lens.

In the above invention, additionally, the scanning confocal microscope may further include a partition separating the examination space and the optical system space, a through-hole through which the laser light passes may be formed in the partition and the incubation container, and a specimen container containing the specimen may be disposed at a position where the specimen container seals off the through-hole of the incubation container, thereby separating the incubation container and the optical system space based on humidity.

This allows the specimen container in the incubation container to be positioned directly opposite the objective lens of the optical system space in close proximity inside the through-hole and also allows the incubation container and the optical system space to be readily separated based on humidity.

In the above invention, additionally, an adhesive member may be provided so that the incubation container is supported on the partition by adhesion.

This allows the incubation container to be stably supported on the partition by adhesion.

In the above invention, alternatively, the scanning confocal microscope may further include a partition between the incubation container and the optical system space, a through-hole through which the laser light passes may be formed in the partition, the objective lens may be inserted in the through-hole, and an elastic member may be disposed between an inner surface of the through-hole and an outer surface of the objective lens to seal a gap therebetween, thereby separating the incubation container and the optical system space based on humidity.

This allows the elastic member to be elastically deformed to seal the gap between the inner surface of the through-hole of the partition and the outer surface of the objective lens, so that the incubation container and the optical system space can be readily separated based on humidity. In this case, a focusing operation can be readily performed because the objective lens can be readily moved in the optical-axis direction in sliding contact with the elastic member.

In the above invention, additionally, the scanning confocal microscope may further include a control unit that is supplied in advance with an offset between an actuation position of the focus adjustment mechanism where the intensity of the laser light reflected on a reference plane near the specimen and passing through the confocal pinhole is maximized and an actuation position of the focus adjustment mechanism where actual examination is carried out to obtain specimen data; that searches for the actuation position of the focus adjustment mechanism where the intensity of the laser light reflected on the reference plane is maximized before examination at predetermined intervals; and that moves the focus adjustment mechanism to a position where a site of interest on the specimen is actually examined, based on the offset.

This allows the objective lens to be quickly moved into a focal position where actual examination of the specimen is carried out with reference to the reference plane in the optical-axis direction. The reference plane may be any plane selected from sites for which the control unit can readily search, for example, a surface of the incubation container.

In the above invention, additionally, the laser light with which the reference plane is irradiated may have a longer wavelength than the laser light used to examine the specimen.

This prevents a deterioration in the condition of the specimen because laser light with less phototoxicity for the specimen can be used as the laser light with which the specimen is irradiated when searching for the reference plane.

In the above invention, additionally, the optical system space and the incubation container may be separated based on humidity by a pressure-increasing unit configured to increase the air pressure in the optical system space.

This prevents the high-humidity atmosphere in the incubation container from entering the optical system space because the pressure-increasing unit operates to increase the air pressure in the optical system space, so that the incubation container and the optical system space can be readily separated based on humidity.

The present invention affords the advantage of providing an image while preventing a shifting of the examination site, a decrease in brightness, and blurring due to strain caused in the optical and mechanical systems by thermal effects in the high-temperature, high-humidity incubation container.

### BRIEF DESCRIPTION OF THE SEVERAL VIEWS OF THE DRAWINGS

FIG. 1 is a schematic overall view of a scanning confocal microscope according to an embodiment of the present invention;

FIG. 2 is a schematic overall view of a first modification of the scanning confocal microscope of FIG. 1;

FIG. 3 is a schematic overall view of a second modification of the scanning confocal microscope of FIG. 1;

FIG. 4 is a schematic overall view of a third modification of the scanning confocal microscope of FIG. 1;

FIG. 5 is a schematic overall view of a fourth modification of the scanning confocal microscope of FIG. 1;

FIG. 6 is a schematic overall view of a fifth modification of the scanning confocal microscope of FIG. 1;

FIG. 7A is a schematic overall view of a sixth modification of the scanning confocal microscope of FIG. 1, showing an escape position of a tube through which a liquid-immersion medium is supplied;

FIG. 7B is a schematic overall view of the sixth modification of the scanning confocal microscope of FIG. 1, showing a supply position of the tube through which the liquid-immersion medium is supplied;

FIG. 8 is a partial enlarged view of a seventh modification of the scanning confocal microscope of FIG. 1;

FIG. 9 is a schematic overall view of an eighth modification of the scanning confocal microscope of FIG. 1; and

FIG. 10 is a schematic overall view of a ninth modification of the scanning confocal microscope of FIG. 1.

### DETAILED DESCRIPTION OF THE INVENTION

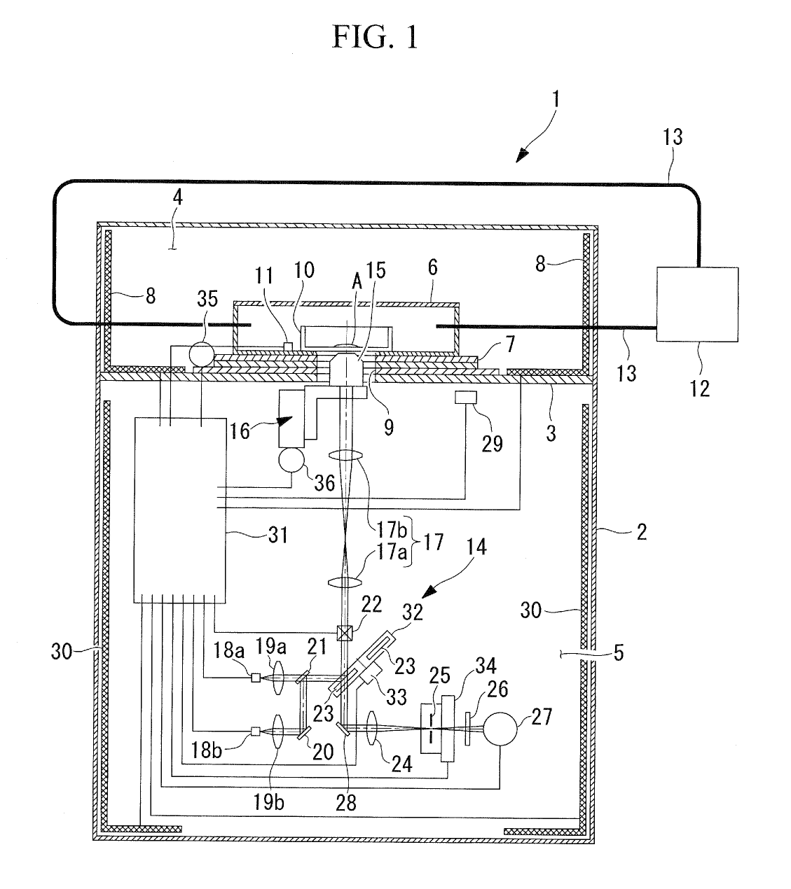

A scanning confocal microscope 1 according to an embodiment of the present invention will now be described with reference to FIG. 1.

In FIG. 1, the scanning confocal microscope 1 according to this embodiment includes an outer cover 2 having a rectangular box shape and formed of a heat insulator and a partition 3 disposed horizontally in the outer cover 2 to partition the inner space into an upper examination space 4 and a lower optical system space 5.

The upper examination space 4 accommodates an incubation container 6, a motor-driven stage 7 supporting the incubation container 6, and a heater (heating unit or temperature-maintaining unit for an examination space) 8.

The incubation container 6 is mounted on the motor-driven stage 7 and can be moved horizontally, for example, by the operation of the motor-driven stage 7.

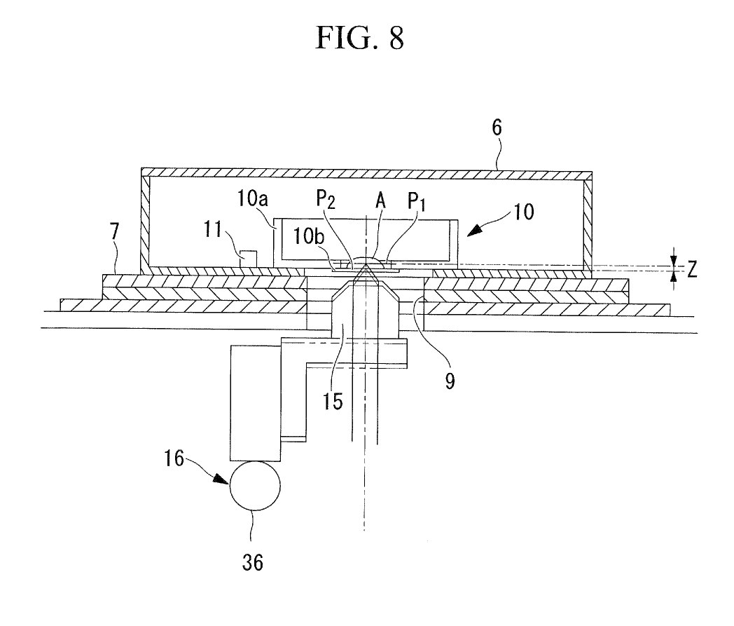

A through-hole 9 extends vertically through the bottom of the incubation container 6, the motor-driven stage 7, and the partition 3 so that the space in the incubation container 6 communicates with the optical system space 5. The incubation container 6 accommodates a specimen container 10 containing a specimen A and formed of a transparent material. The specimen container 10 used may be, for example, a Petri dish 10a having a glass plate 10b that has a thickness equivalent to that of a typical glass cover and that is bonded to a flat underside of the dish 10a (see FIG. 8), or may also be a well plate. The specimen container 10 is disposed on the bottom surface of the incubation container 6 at a position where it covers and seals off the through-hole 9, thereby separating the space in the incubation container 6 and the optical system space 5 based on humidity.

The incubation container 6 also accommodates a temperature sensor (temperature-maintaining unit for an examination space) 11 configured to sense the temperature in the incubation container 6. In addition, an environmental control unit (hot-air supplying unit) 12 is connected to the incubation container 6 through tubes 13 to circulate air with a temperature of 37° C., a humidity of 90% to 100%, and a CO₂ concentration of 5%.

The heater 8 heats the examination space 4 to a temperature equivalent to the temperature in the incubation container 6.

The optical system space 5 accommodates a microscope body 14. The microscope body 14 includes an objective lens 15 disposed directly below and separated from the underside of the specimen container 10 with its optical axis aligned in the vertical direction, a focus adjustment mechanism 16 configured to actuate the objective lens 15 in the optical-axis direction, a scanner optical system 17, a first semiconductor laser (laser light source) 18a configured to emit laser light with a first wavelength, a second semiconductor laser (laser light source) 18b configured to emit laser light with a second wavelength, collimator lenses (laser-light introducing optical system) 19a and 19b configured to substantially collimate the laser light from the semiconductor laser 18a and 18b, respectively, a mirror (laser-light introducing optical system) 20 and a dichroic mirror (laser-light introducing optical system) 21 configured to direct the laser light into the same optical path, and a light-scanning unit 22 including a galvanometer mirror configured to scan the specimen A with the laser light in two dimensions.

The microscope body 14 further includes dichroic mirrors (laser-light introducing optical system) 23 configured to transmit fluorescence emitted from the specimen A after it passes through the objective lens 15, the scanner optical system 17, and the light-scanning unit 22 and to reflect the laser light; a confocal lens 24 configured to focus the fluorescence passing through the dichroic mirrors 23; a confocal pinhole 25 disposed at the focal position of the confocal lens 24; a barrier filter 26 configured to block laser light contained in the fluorescence passing through the confocal pinhole 25; and a light detector 27 configured to detect the fluorescence passing through the barrier filter 26. In FIG. 1, reference numeral 28 refers to a mirror.

The optical system space 5 also accommodates a temperature sensor (temperature-maintaining unit for an optical system space) 29 configured to sense the temperature in the optical system space 5 and a heater (heating unit or temperature-maintaining unit for an optical system space) 30 configured to heat the air in the optical system space 5.

The optical system space 5 also accommodates a control unit 31.

The scanner optical system 17 includes a pupil projection lens 17a configured to form an intermediate image by focusing the laser light scanned in two dimensions and a focusing lens 17b configured to substantially collimate the laser light after the formation of the intermediate image so that it enters the objective lens 15.

The dichroic mirrors 23 are mounted on a rotatable turret 32 that is actuated by a stepping motor 33 so that one dichroic mirror 23 is selectively placed in the optical path.

The confocal pinhole 25 is configured so that its position can be controlled in two directions perpendicular to the optical axis by a pinhole-position controlling unit 34.

Switching the dichroic mirrors 23 causes a deviation in the focal position of the confocal lens 24 because the dichroic mirrors 23 have slight angular differences. To correct the position of the confocal pinhole 25 for each dichroic mirror 23, the position to which the confocal pinhole 25 needs to be shifted by the pinhole-position controlling unit 34 is determined for each dichroic mirror 23 and is stored in advance in a memory (not shown) in the control unit 31.

The control unit 31 is configured to drive the semiconductor lasers 18a and 18b, the light-scanning unit 22, the light detector 27, a motor 35 of the motor-driven stage 7, a motor 36 of the focus adjustment mechanism 16, the stepping motor 33 of the turret 32, and the pinhole-position controlling unit 34. The individual units are controlled based on control parameters stored in the control unit 31.

The control parameters are control values used to correct manufacturing errors so that the individual units can operate successfully; therefore, they differ from system to system.

Examples of the control parameters include the relationship between the current supplied to drive the semiconductor lasers 18a and 18b and brightness, the scanning center and scanning range of the light-scanning unit 22, the position of the confocal pinhole 25 for each dichroic mirror 23, and the analog bias of the light detector 27, namely, a photomultiplier tube. These control parameters are set with each part of the optical system space 5 maintained at the temperature in use.

This setting operation is generally carried out before shipping from the factory, on initial system setup on-site, or during maintenance/inspection.

For a system capable of changing the temperature maintained in the optical system space 5, control parameters optimized for different temperatures may be prepared and stored in advance so that the control parameters corresponding to the temperature selected can be retrieved and used when the system is used.

The control unit 31 drives and controls the heaters 8 and 30 based on sensing signals from the temperature sensor 11 disposed in the incubation container 6 and the temperature sensor 29 disposed in the optical system space 5 so that the temperatures sensed by the temperature sensors 11 and 29 are maintained at 37° C.

The operation of the scanning confocal microscope 1 according to this embodiment, thus configured, will now be described.

To examine the specimen A, such as a living cell, using the scanning confocal microscope 1 according to this embodiment, the specimen container 10 is accommodated in the incubation container 6 with the specimen A immobilized on the bottom surface of the specimen container 10, and the through-hole 9 of the motor-driven stage 7 is sealed off by the underside of the specimen container 10.

In this state, the environmental control unit 12 is driven to circulate air suitable for the incubation environment in the incubation container 6, namely, air with a temperature of 37° C., a humidity of 100%, and a CO₂ concentration of 5%.

In addition, the heaters 8 and 30 are driven by the operation of the control unit 31 to heat the incubation container 6 and the optical system space 5, respectively, so that the temperature sensor 11 in the incubation container 6 and the temperature sensor 29 in the optical system space 5 read 37° C.

While the examination space 4 and the optical system space 5 are maintained at 37° C., the semiconductor lasers 18a and 18b are driven to emit laser light. The laser light is reflected by one of the dichroic mirrors 23, is subjected to scanning in two dimensions by the light-scanning unit 22, is focused by the pupil projection lens 17a, the focusing lens 17b, and the objective lens 15, and irradiates the specimen A disposed on the bottom surface of the specimen container 10.

The laser light excites a fluorescent substance contained in irradiated positions on the specimen A so that it emits fluorescence. The fluorescence is collected by the objective lens 15, passes through the focusing lens 17b, the pupil projection lens 17a, and the light-scanning unit 22, is separated from the laser light by the dichroic mirror 23, and is focused by the confocal lens 24. Of the focused fluorescence, only the fluorescence emitted from the focal plane of the objective lens 15 passes through the confocal pinhole 25 and is detected by the light detector 27.

The control unit 31 receives information about the brightness of the fluorescence detected by the light detector 27 and stores the brightness information in correspondence with scanning position information obtained by the light-scanning unit 22 upon detection of the brightness information, thereby enabling acquisition of a two-dimensional frame image.

The scanning confocal microscope 1 according to this embodiment maintains the incubation container 6, the examination space 4, which accommodates the incubation container 6, and the optical system space 5, which accommodates the optical systems, at 37° C. Unlike known microscopes, which maintain only the incubation container 6 at constant temperature, the scanning confocal microscope 1 causes no temperature gradient extending from around the incubation container 6, thus preventing a shift in the position of the confocal pinhole 25 and a deviation in focal position. This results in the advantage of enabling stable acquisition of a fluorescent image containing appropriate information after long-term examination.

In this embodiment, additionally, the control parameters are set in an environment maintained at the temperature in use. This enables stable acquisition of a fluorescent image containing appropriate information in an environment whose temperature differs from room temperature.

In addition, the incubation container 6 is disposed in the examination space 4, surrounded by the outer cover 2, thus effectively preventing variations in the temperature of the specimen A due to variations in outside air temperature.

Similarly, the optical system space 5 is surrounded by the outer cover 2, thus preventing strain in the optical systems due to the effect of variations in outside air temperature.

In addition, the space in the incubation container 6, which accommodates the specimen A, and the optical system space 5, which accommodates the optical systems, are separated based on humidity so that no moisture is deposited on the components of the optical systems, including the semiconductor lasers 18a and 18b, the light-scanning unit 22, the objective lens 15, and the scanner optical system 17. This allows long-term examination under constant, stable conditions.

In addition, because the examination space 4 and the optical system space 5 are maintained at 37° C., the specimen A, such as a living cell, in the incubation container 6 can be maintained in a live, healthy condition without exposure to low temperature.

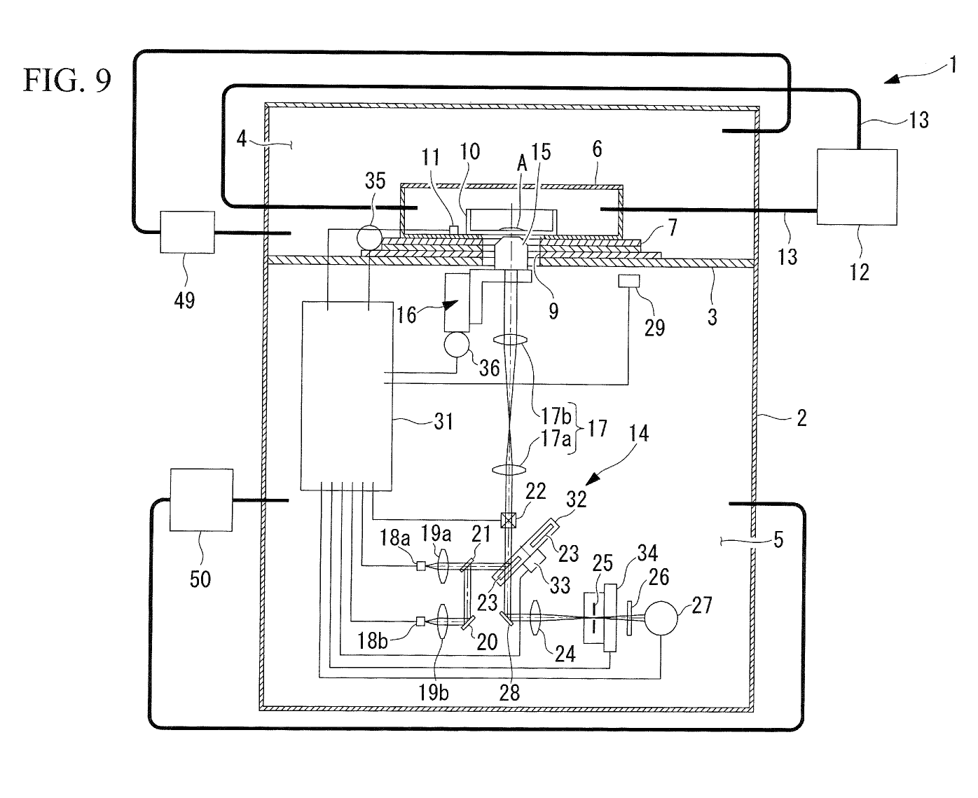

Referring to FIG. 9, the heaters 8 and 30 may be replaced with hot-air supplying units 49 and 50, respectively. The hot-air supplying units 49 and 50 supply air heated to 37° C., for example, to the examination space 4 and the optical system space 5, respectively, to maintain these spaces 4 and 5 at constant temperature.

To prevent moisture from leaking into the optical system space 5, in this embodiment, the specimen container 10 may be bonded to the inner surface of the incubation container 6 by applying an adhesive material such as silicone rubber to the underside of the specimen container 10. Alternatively, the air pressure in the optical system space 5 may be set to be higher than the air pressure in the incubation container 6. This may be achieved by, for example, increasing the pressure of the air supplied from the hot-air supplying unit 50 of FIG. 9 into the optical system space 5.

The optical system space 5, which is maintained at the temperature in the incubation container 6, namely, 37° C., in this embodiment, may be maintained at any temperature in the range of 30 to 37° C. If the semiconductor lasers 18a and 18b are maintained at 35° C. with Peltier devices (not shown), for example, the temperature in the optical system space 5 may be set to 30° C. to stabilize the outputs of the semiconductor lasers 18a and 18b because the outputs become more stable with increasing difference between the temperature of the semiconductor lasers 18a and 18b and the ambient temperature.

If the optical system space 5 is maintained at 30° C. and the incubation container 6 is maintained at 37° C., the temperature difference is 7° C., which falls within an acceptable range in terms of both the effect of the temperature difference on the specimen A and the effect of the temperature gradient on the optical systems.

In addition to the semiconductor lasers 18a and 18b, the optimum temperature to be maintained may be set in the range of 30 to 37° C. for other components that have temperature-dependent characteristics, including the light detector 27 and the light-scanning unit 22.

The optical system space 5 may also be configured so that the temperature therein can be changed depending on the condition of the specimen A and the site in the microscope 1 to which special attention must be paid. In this case, control parameters corresponding to different temperatures to be set may be stored in advance, and they may be retrieved and used based on the temperature selected.

If the temperature maintained in the optical system space 5 differs from that maintained in the incubation container 6 and, in particular, if the objective lens 15 has a metal casing, it may be covered with a cap formed of a material having a heat-insulating effect, such as resin, because a metal casing readily transfers heat from the objective lens 15 to the incubation container 6.

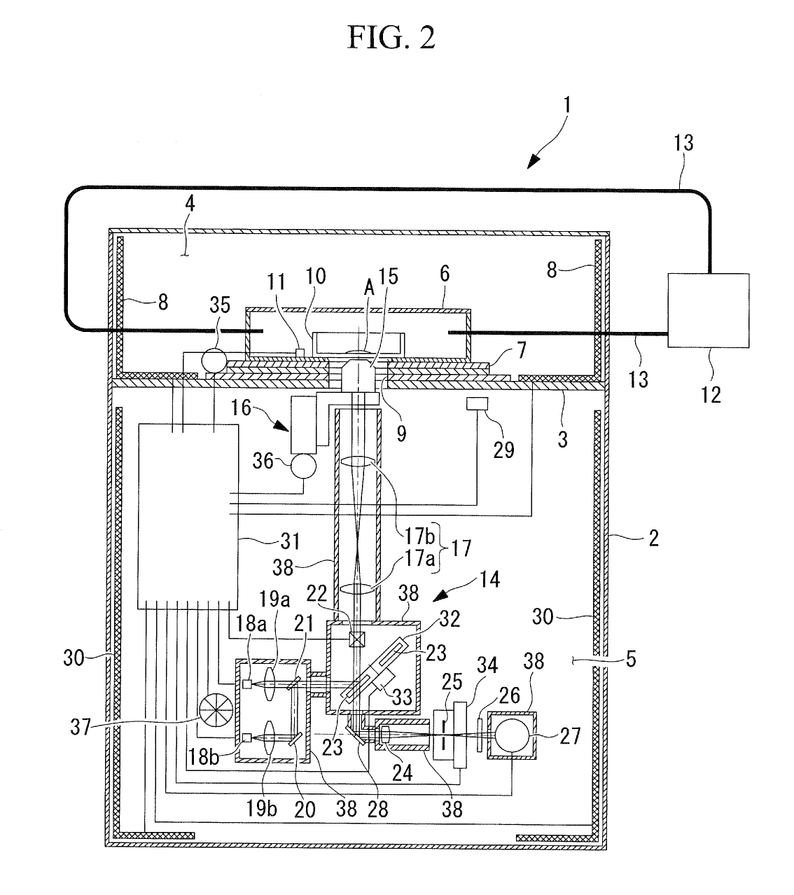

Referring to FIG. 2, the scanning confocal microscope 1 according to this embodiment may further include a cooling fan (fan) 37 to cool the semiconductor lasers 18a and 18b because they radiate much heat. In addition, a fan (not shown) may be disposed in the optical system space 5 to stir the air therein so that the temperature becomes uniform.

In such cases, an air flow occurring across the optical path of the laser light causes an uneven refractive-index distribution in the air, thus deflecting the laser light. This can cause a problem in that the light beam can no longer be focused at the position of the confocal pinhole 25. Another problem is that an air flow directly applied to the semiconductor lasers 18a and 18b, the light-scanning unit 22, and the light detector 27, which have temperature-dependent characteristics, can cause, for example, variations in output, a deviation in scanning position due to a shifting of the optical axis, and variations in sensitivity, thus preventing appropriate examination.

To prevent direct exposure to an air flow, as shown in FIG. 2, covers (air-flow shielding members) 38 may be disposed so as to surround the semiconductor lasers 18a and 18b, the light-scanning unit 22, the scanner optical system 17, the confocal lens 24, and the light detector 27. If the covers 38 are used, they are preferably thin and formed of a material with high thermal conductivity, such as metal, so that no temperature difference occurs between the inside and outside of the covers 38. In addition, the outer surfaces of the covers 38 may be subjected to blackening treatment, for example, coating with black paint, so that they can quickly absorb outside heat and release it inside the covers 38. This effectively prevents a temperature gradient between the inside and outside of the covers 38.

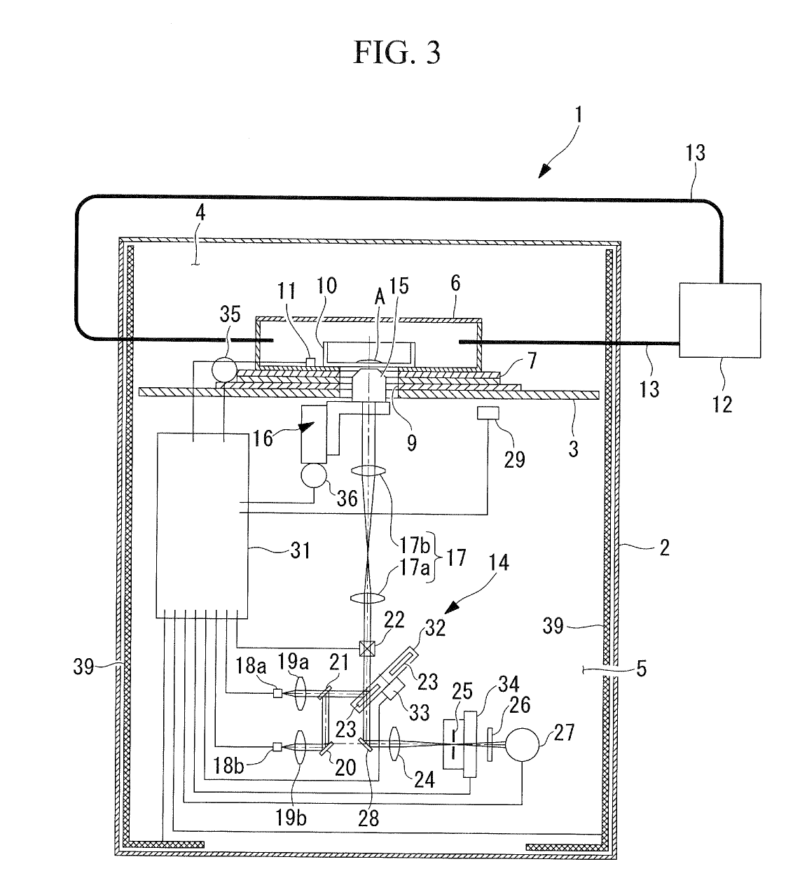

Although the examination space 4 and the optical system space 5 are completely partitioned by the partition 3 in the above embodiment, they may be integrated instead into a single space accommodating the incubation container 6, as shown in FIG. 3.

In this case, the structure of the microscope 1 can be simplified because, for example, a common heater 39 can be used, and the temperature in the entire space becomes more uniform.

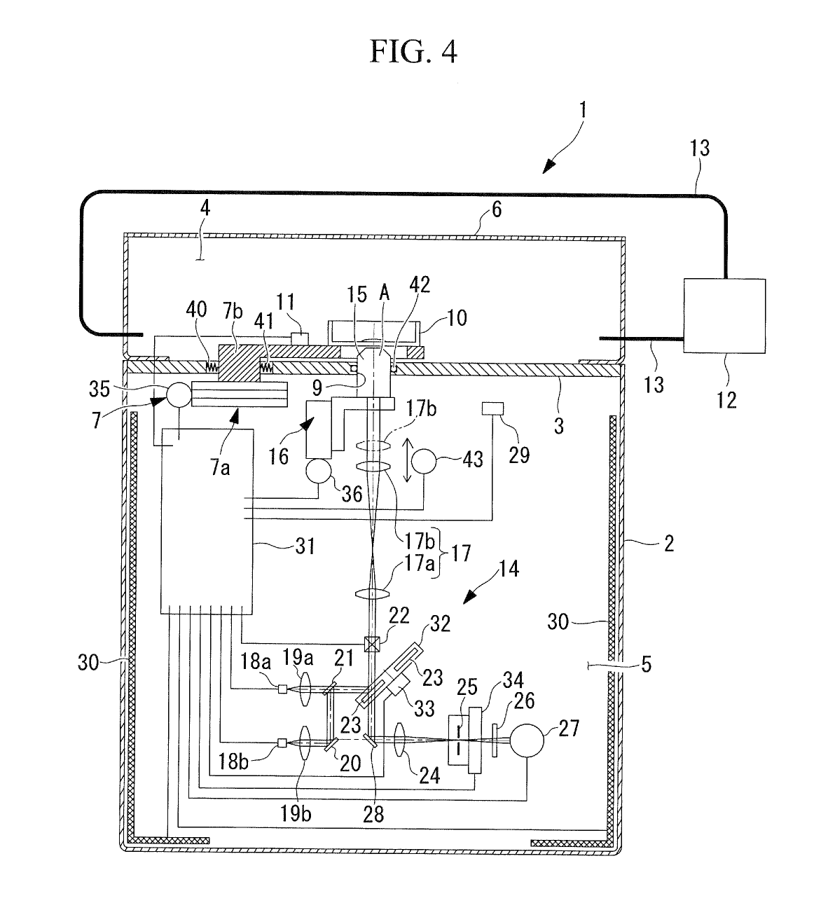

Referring to FIG. 4, additionally, the entire examination space 4 may be used as the incubation container 6. In other words, air with a temperature of 37° C., a humidity of 100%, and a CO₂ concentration of 5% may be circulated through the entire examination space 4. In this case, the stage 7 may be configured such that a drive part 7a is disposed in the optical system space 5, which is isolated from the high-temperature, high-humidity examination space 4 by the partition 3 based on humidity, such that an arm 7b supporting the specimen container 10 extends through a slit 40 of the partition 3 into the examination space 4, and such that a gap between the arm 7b and the slit 40 is sealed off with an extendable member such as a bellows 41.

In addition, the objective lens 15 may be inserted into the through-hole 9 of the partition 3, and a gap between the outer surface of the casing of the objective lens 15 and the inner surface of the through-hole 9 may be sealed with an O-ring (elastic member) 42.

The objective lens 15 used may be one having low magnification and high numerical aperture, and the scanner optical system 17 used may be one having a motor-driven zoom mechanism including a motor (pupil-projection-magnification changing unit) 43 that is driven to change its pupil projection magnification (the pupil projection magnification is determined by the ratio of the focal length of the pupil projection lens to the focal length of the focusing lens).

This makes it possible to cover a range from low magnification to high magnification only with the single objective lens 15. In other words, because the low-magnification, high-numerical-aperture objective lens 15 has a large pupil diameter, the beam diameter must be increased by increasing the pupil projection magnification to fill the pupil for high-resolution examination. In this case, the light-scanning unit 22 cannot provide a sufficient scanning angle to ensure a normal field angle of the scanning confocal microscope 1. Therefore, low-magnification examination may be carried out by decreasing the pupil projection magnification at the expense of resolution, whereas high-magnification examination may be carried out by increasing the pupil projection magnification for high resolution.

The pupil projection magnification can also be changed using combinations of pupil projection lenses 17a and focusing lenses 17b with different focal lengths in a switchable manner.

This provides the advantages of simpler optical design as compared to the zoom system, a reduced number of lenses, low light loss, and low manufacturing costs.

Alternatively, two optical paths with different pupil projection magnifications may be provided so that they can be switched by, for example, inserting and removing a mirror.

In this case, the pupil projection lens 17a and the focusing lens 17b can be fixed relative to each other to prevent a misalignment due to switching and the resulting drop in performance, thus enabling highly reproducible examination.

In this way, the temperature, humidity, and CO₂ concentration in the examination space 4 can be directly controlled with the environmental control unit 12 to maintain stable environmental conditions.

In addition, it is possible to switch between low-magnification examination and high-magnification, high-resolution examination without replacing the objective lens 15, thus preventing intrusion of moisture into the optical system space 5.

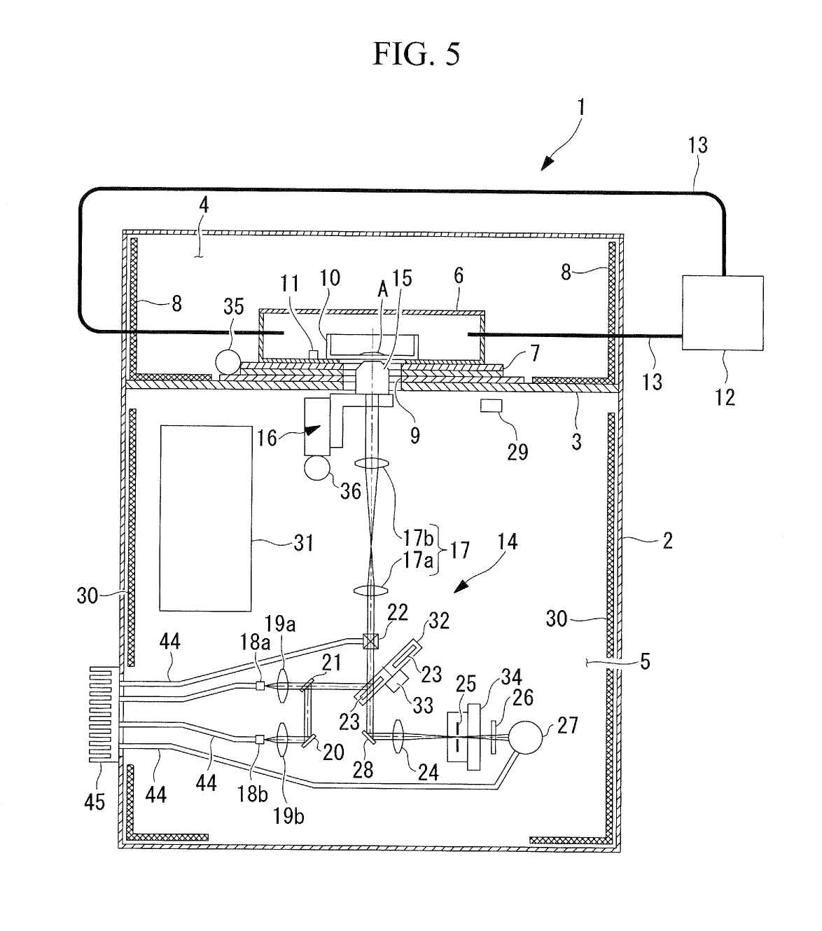

In this embodiment, much heat is generated particularly by the semiconductor lasers 18a and 18b, the light-scanning unit 22, and the light detector (cooled photomultiplier tube) 27. Referring to FIG. 5, this heat may be transferred to the outside of the outer cover 2 by connecting heat pipes (heat-transferring members) 44 and may be dissipated through a heat sink (heat-dissipating member) 45 disposed outside the outer cover 2.

This eliminates the need for the cooling fan 37 and avoids a temperature rise in the optical system space 5, thus allowing stable temperature control.

If the light detector 27 used is a cooled photomultiplier tube, the optical system space 5 can be maintained at relatively high temperature to acquire a fluorescent image with low noise.

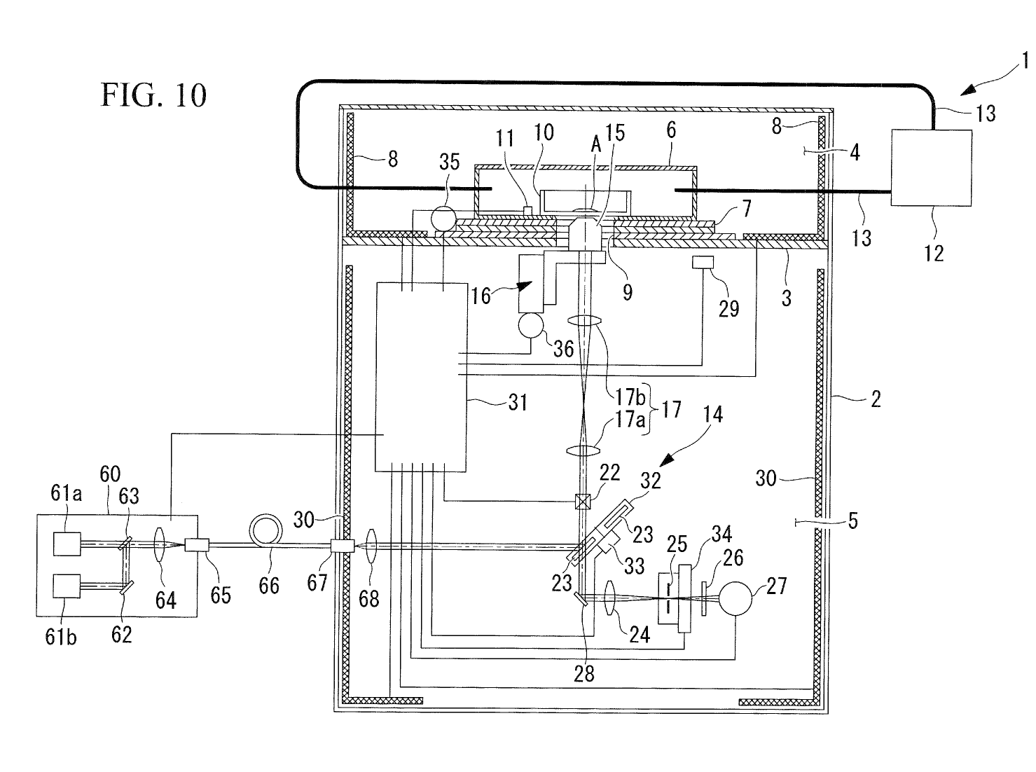

Referring to FIG. 10, the laser light sources, which are heat sources, may be a laser light source unit 60 that is disposed outside the optical system space 5 and that introduces laser light into the optical system space 5 through an optical fiber 66. This laser light source unit 60 includes laser light sources 61a and 61b that emit laser light of predetermined wavelengths, a reflecting mirror 62, a dichroic mirror 63, a coupling lens 64, and a fiber connector 65. The laser light transmitted through the optical fiber 66 is introduced into a microscope optical system through a fiber connector 67 and a collimator lens 68.

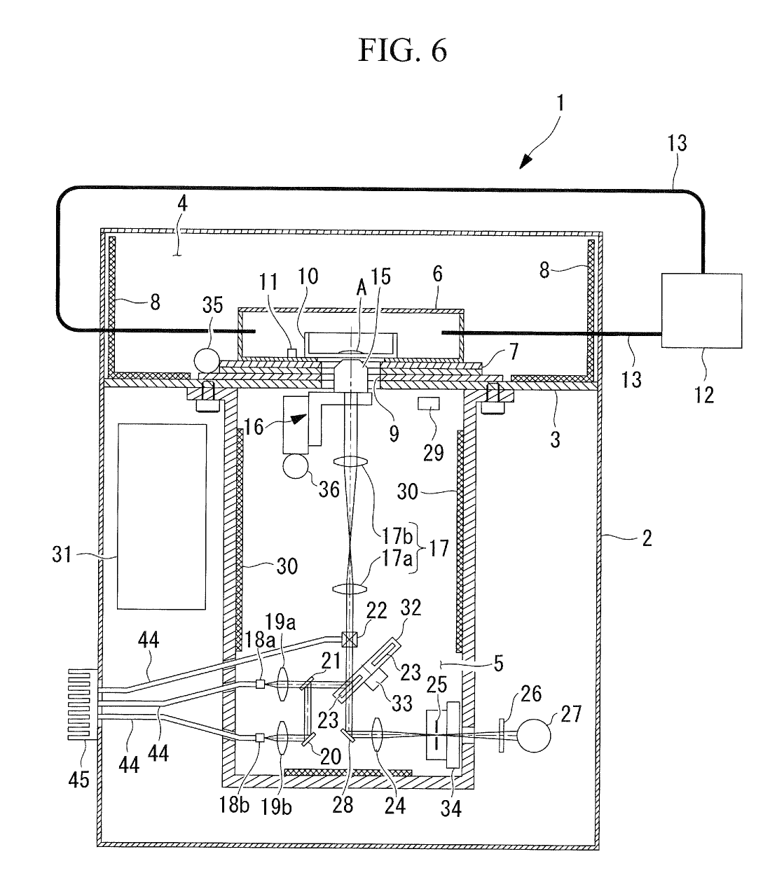

Although all components constituting the microscope body 14 are disposed in the optical system space 5 in the above embodiment, the light detector 27 may instead be disposed outside the optical system space 5, which is maintained at constant temperature, as shown in FIG. 6. A photomultiplier tube constituting the light detector 27 does not require high positional accuracy and can therefore be disposed outside the optical system space 5 to reduce its effect as a heat source on the other optical and mechanical systems. If the light detector 27 is disposed outside the optical system space 5, additionally, it is possible to reduce the size of the optical system space 5 itself and to maintain it at constant temperature more readily.

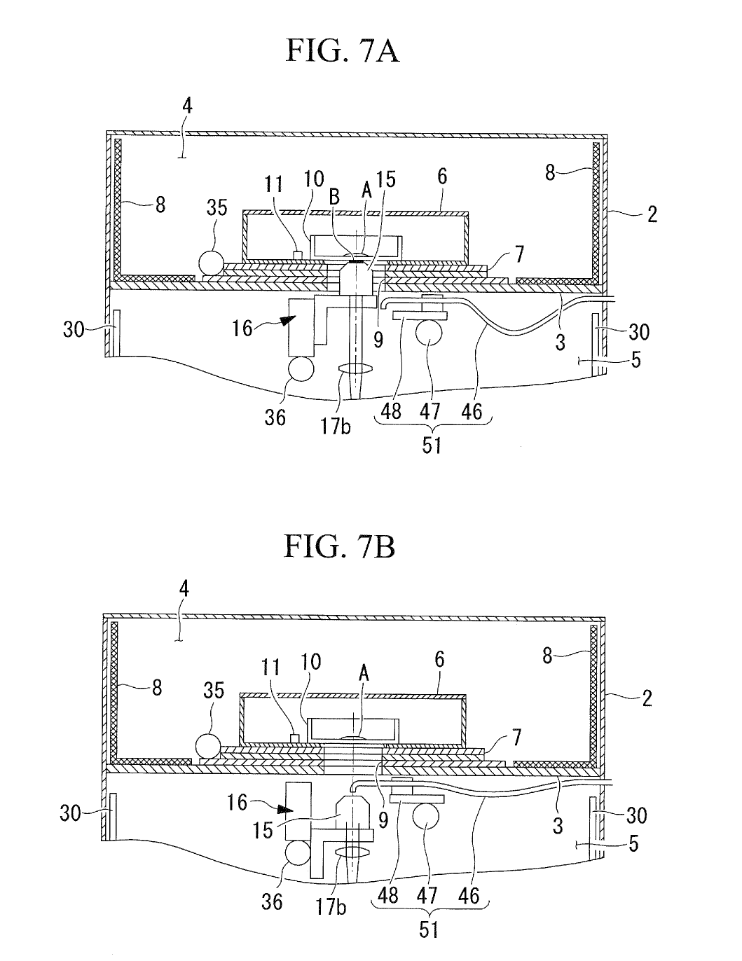

For the scanning confocal microscope 1 to ensure the confocal effect, a liquid-immersion objective lens 15 with a liquid-immersion medium B supplied between the objective lens 15 and the specimen container 10 is preferably used, as shown in FIGS. 7A and 7B, because the objective lens 15 requires high numerical aperture. The liquid-immersion medium B may be supplied from a liquid-immersion-medium supplying apparatus 51 through a tube (liquid-immersion-medium supplying unit) 46 so that the objective lens 15 is constantly filled with the liquid-immersion medium B without drying out during long-term examination.

In this case, a tube-moving mechanism 48 may be actuated with a stepping motor 47 to move the tube 46 between a position where the tube 46 supplies the liquid-immersion medium B between the tip of the objective lens 15 and the specimen container 10 (FIG. 7B) and an escape position to which the tube 46 is moved outward in the radial direction of the objective lens 15 (FIG. 7A).

For long-term time-lapse examination, in which examination is repeated multiple times at predetermined time intervals, the same examination plane must be examined at time intervals. This often demands detection of the examination plane for each examination to increase examination accuracy. Referring to FIG. 8, preferably, an offset Z between an examination position (solid line) where the focal plane of the objective lens 15 is positioned in an examination plane P1 and a reference plane P2 near the specimen A, for example, a reference position where the interface between the glass plate 10b and the specimen A is detected, is initially determined and stored in the control unit 31 before the specimen A is examined.

With this configuration, for each of the examinations carried out at predetermined time intervals, the control unit 31 searches for the reference plane P2 immediately before the actuation of the focus adjustment mechanism 16 to move the objective lens 15 by the offset Z stored. This control allows the focal plane of the objective lens 15 to be readily set to the same examination plane P1 at any time. Searching for the reference plane P2 results in that the focal position of the objective lens 15 is moved by the focus adjustment mechanism 16, and the position is determined where the intensity of the laser light reflected on the reference plane P2 which passes through the confocal pinhole 25 is maximized.

In this case, the laser light passing through the objective lens 15 when the control unit 31 searches for the reference plane P2 preferably has a sufficiently longer wavelength than the laser light passing through the objective lens 15 when the examination is carried out. This reduces the phototoxicity of the specimen A, such as a living cell, to the laser light, thus maintaining the specimen A in a healthy condition.

What is claimed is:

1. A scanning confocal microscope comprising an incubation container that has a space in which a specimen is disposed and that can maintain an internal environment thereof at a predetermined temperature and high humidity and an optical system space adjacent to the incubation container and separated therefrom based on humidity, wherein
the optical system space accommodates a light-scanning unit and a scanner optical system configured to scan the specimen with laser light in two dimensions, an objective lens configured to focus the laser light scanned by the light-scanning unit on the specimen and to collect light from the specimen, a confocal pinhole through which the light collected by the objective lens passes after passing through the scanner optical system and the light-scanning unit, and a focus adjustment mechanism configured to actuate the objective lens in an optical-axis direction; and
the optical system space further accommodates a temperature-maintaining unit for the optical system space to maintain the optical system space at a temperature substantially equal to the temperature in the incubation container.

2. The scanning confocal microscope according to claim 1, wherein the optical system space accommodates the incubation container.

3. The scanning confocal microscope according to claim 1, wherein
the incubation container is disposed in an examination space separated from the incubation container based on humidity; and
the examination space accommodates a temperature-maintaining unit for the examination space to maintain the examination space at a temperature substantially equal to the temperature in the incubation container.

4. The scanning confocal microscope according to claim 1, wherein the incubation container is maintained at a temperature of 37±1° C. and a humidity of 90% to 100%.

5. The scanning confocal microscope according to claim 4, wherein the temperature-maintaining unit for the optical system space maintains the optical system space at a predetermined temperature between about 30° C. and 37° C.

6. The scanning confocal microscope according to claim 1, wherein the temperature-maintaining unit for the optical system space includes a temperature sensor configured to measure the temperature in the optical system space and a heating unit configured to heat air in the optical system space.

7. The scanning confocal microscope according to claim 3, wherein the temperature-maintaining unit for the examination space includes a temperature sensor configured to measure the temperature in the examination space and a heating unit configured to heat air in the examination space.

8. The scanning confocal microscope according to claim 6, wherein the heating unit is a hot-air supplying unit configured to supply air maintained at constant temperature.

9. The scanning confocal microscope according to claim 1, wherein the optical system space further accommodates a laser light source configured to emit the laser light and a laser-light introducing optical system configured to guide the laser light emitted from the laser light source to the light-scanning unit.

10. The scanning confocal microscope according to claim 1, wherein
a laser light source configured to emit the laser light is disposed outside the optical system space; and
an optical fiber configured to guide the laser light emitted from the laser light source into the optical system space is provided.

11. The scanning confocal microscope according to claim 1, wherein a light detector configured to detect the light passing through the confocal pinhole is disposed outside the optical system space.

12. The scanning confocal microscope according to claim 1, wherein the optical system space is surrounded by an outer cover formed of a heat insulator.

13. The scanning confocal microscope according to claim 1, wherein control parameters, including at least one of the scanning range and scanning position of the laser light on the specimen by the scanner optical system, and the position of the confocal pinhole, are set with the optical system space maintained at a temperature in use by the temperature-maintaining unit for the optical system space.

14. The scanning confocal microscope according to claim 13, wherein a parameter-storing unit is provided to store the control parameters in correspondence with temperatures in the optical system space.

15. The scanning confocal microscope according to claim 1, wherein
the optical system space further accommodates a fan configured to produce an air flow in the optical system space; and
an air-flow shielding member is disposed around an optical path of the laser light.

16. The scanning confocal microscope according to claim 15, wherein the air-flow shielding member has an outer surface subjected to blackening treatment.

17. The scanning confocal microscope according to claim 1, wherein a resin cover is provided so as to cover a metal portion at a tip of the objective lens.

18. The scanning confocal microscope according to claim 9, wherein
the laser light source is a semiconductor laser; and
a heat-transferring member is provided so as to transfer heat generated by the laser light source to the outside of the optical system space.

19. The scanning confocal microscope according to claim 18, wherein the heat-transferring member is a heat pipe.

20. The scanning confocal microscope according to claim 18, wherein
a heat-dissipating member is disposed at an end of the heat-transferring member outside the optical system space.

21. The scanning confocal microscope according to claim 1, wherein a liquid-immersion-medium supplying unit is provided to supply a liquid-immersion medium between the objective lens and the specimen.

22. The scanning confocal microscope according to claim 1, wherein
a light detector is constituted of a cooled photomultiplier tube disposed in the optical system space; and
a heat-transferring member is provided so as to transfer heat generated by the light detector to the outside of the optical system space.

23. The scanning confocal microscope according to claim 1, wherein
the scanning optical system includes a pupil projection lens and a focusing lens; and
a pupil-projection-magnification changing unit is provided to change a pupil projection magnification based on the ratio of the focal length of the pupil projection lens to the focal length of the focusing lens.

24. The scanning confocal microscope according to claim 23, wherein the pupil-projection-magnification changing unit includes a zoom lens constituting at least one of the pupil projection lens and the focusing lens.

25. The scanning confocal microscope according to claim 3, further comprising a partition separating the examination space and the optical system space, wherein
a through-hole through which the laser light passes is formed in the partition and the incubation container; and
a specimen container containing the specimen is disposed at a position where the specimen container seals off the through-hole of the incubation container, thereby separating the incubation container and the optical system space based on humidity.

26. The scanning confocal microscope according to claim 25, wherein an adhesive member is provided so that the incubation container is supported on the partition by adhesion.

27. The scanning confocal microscope according to claim 1, further comprising:
a partition between the incubation container and the optical system space,
wherein a through-hole through which the laser light passes is formed in the partition;
the objective lens is inserted in the through-hole; and
an elastic member is provided between an inner surface of the through-hole and an outer surface of the objective lens to seal a gap therebetween, thereby separating the incubation container and the optical system space based on humidity.

28. The scanning confocal microscope according to claim 1, further comprising a control unit that is supplied in advance with an offset between an actuation position of the focus adjustment mechanism where the intensity of the laser light reflected on a reference plane near the specimen and passing through the confocal pinhole is maximized and an actuation position of the focus adjustment mechanism where actual examination is carried out to obtain specimen data; that searches for the actuation position of the focus adjustment mechanism where the intensity of the laser light reflected on the reference plane is maximized before examination at predetermined intervals; and that moves the focus adjustment mechanism to a position where a site of interest on the specimen is actually examined, based on the offset.

29. The scanning confocal microscope according to claim 28, wherein the laser light with which the reference plane is irradiated has a longer wavelength than the laser light used to examine the specimen.

30. The scanning confocal microscope according to claim 1, wherein the optical system space and the incubation container are separated based on humidity by a pressure-increasing unit configured to increase the air pressure in the optical system space.

31. A scanning confocal microscope comprising an incubation container that has a space in which a specimen is disposed and that can maintain an internal environment thereof at a predetermined temperature and high humidity and an optical system space adjacent to the incubation container and separated therefrom based on humidity, wherein
the optical system space accommodates a light-scanning unit and a scanner optical system configured to scan the specimen with laser light in two dimensions, an objective lens configured to focus the laser light scanned by the light-scanning unit on the specimen and to collect light from the specimen, a confocal pinhole through which the light collected by the objective lens passes after passing through the scanner optical system and the light-scanning unit, and a focus adjustment mechanism configured to actuate the objective lens in an optical-axis direction; and
the optical system space further accommodates a means configured to maintain the optical system space at a temperature substantially equal to the temperature in the incubation container.

32. The scanning confocal microscope according to claim 31, wherein
the incubation container is disposed in an examination space separated from the incubation container based on humidity; and
the examination space accommodates a means configured to maintain the examination space at a temperature substantially equal to the temperature in the incubation container.

33. The scanning confocal microscope according to claim 7, wherein the heating unit is a hot-air supplying unit configured to supply air maintained at constant temperature.
